(19) United States
(12) Patent Application Publication
(10) Pub. No.: US 2005/0114558 A1
(43) Pub. Date: May 26, 2005

(54) Computer peripheral device for communicating with a computer via wireless network

(76) Inventor: Zhi-Heng Nian, San Chong (TW)

Correspondence Address: Raymond Sun, Suite 155, 20 Corporate Park, Irvine, CA, 92606, US

(21) Appl. No.: 10/758,469

(22) Filed: Jan. 14, 2004

(30) Foreign Application Priority Data
Nov. 21, 2003 (TW) 92132833

(51) Int. Cl. G06F 3/00

(52) U.S. Cl. 710/15

(57) ABSTRACT

A communication system has a peripheral device having a controller that outputs an operating signal, and a processor that receives the operating signal and formats the operating signal into a data packet that complies with a standard wireless network communication protocol, and then wirelessly transmits the data packet. The system further includes a computer having a network card that receives the data packet, and a program that decodes the data packet into a computer control signal to control the operation of the computer.

### BACKGROUND OF THE INVENTION

1. Field of the Invention

The present invention relates to a wireless computer peripheral device that communicates with a computer system, and in particular, to a wireless computer peripheral device that can be used in a wireless network environment.

2. Description of the Prior Art

There are two different ways to transmit data or communicate through a network environment. The first way is a wired communication with a cable, and the second way is a wireless communication with an infrared ray, radio frequency or the like. However, due to the convenience in installation and its mobility in use, wireless communication is becoming increasingly popular.

The wireless network can be further classified according to its range of data transmission. Examples include a wireless wide area network (WWAN), a wireless local area network (WLAN), and a wireless personal area network (WPAN). The WLAN is a network which can be transmitted in a range of about hundred meters, and is usually applied in a single building or in an office. In practical use, WLAN will adopt an Access Point to combine with a wired network so as to promote flexibility in use and to enlarge the transmission range. WLAN protocol is now governed by the Institute of Electrical and Electronic Engineers (IEEE), which essentially introduces several wireless communication protocol standards, such as 802.11 serial, HIPERLAN, HOMERF and 1394, etc. Ad-hoc mode and Infrastucture mode are further defined in 802.11 serial. The former skill discloses a peer-to-peer (computer to computer, or computer to device) wireless communication, and the latter skill discloses a wireless communication between a wired network and a wireless network via an Access Point.

However, the conventional computer peripheral devices typically use radio frequency (RF) to control the operation of a computer system, where each different brand name product has its own different communication protocol for communicating with its own related products. Therefore, it has become more important to allow computer peripheral devices to be incorporated with the prevalent wireless network.

On the other hand, the conventional wireless computer peripheral devices are all in “one-way” communication, so a user cannot observe the detail or progress of the computer system. For example, conventional computer input devices (e.g., mice, joystick, etc.) use a one-way communication with the computer, where the input device provides control signals to control the operation of the computer, but where the computer does not provide any communication signals to the input device. This means that the input device (e.g., mouse or joystick) cannot achieve a so-called tactile feedback, force feedback or vibration feedback from the computer in the wireless communication mode. On the other hand, a two-way communication can be provided where the computer also provides communication signals to the input device.

### SUMMARY OF THE DISCLOSURE

It is an object of the present invention to provide a computer peripheral device for communicating with a computer via a wireless network in a manner which does not utilize cables.

It is another object of the present invention to provide a computer peripheral device that can provide a two-way communication with the computer.

In order to accomplish the objects of the present invention, the present invention provides a communication system that has a peripheral device having a controller that outputs an operating signal, and a processor that receives the operating signal and formats the operating signal into a data packet that complies with a standard wireless network communication protocol, and then wirelessly transmits the data packet. The system further includes a computer having a network card that receives the data packet, and a program that decodes the data packet into a computer control signal to control the operation of the computer.

### BRIEF DESCRIPTION OF THE DRAWINGS

FIG. 1 is a block diagram of a system according to one embodiment of the present invention.

FIG. 2 is a block diagram of a processing unit of the system of FIG. 1.

FIG. 3 illustrates another embodiment according to the present invention.

FIG. 4 illustrates yet another embodiment according to the present invention.

FIG. 5 illustrates a further embodiment according to the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

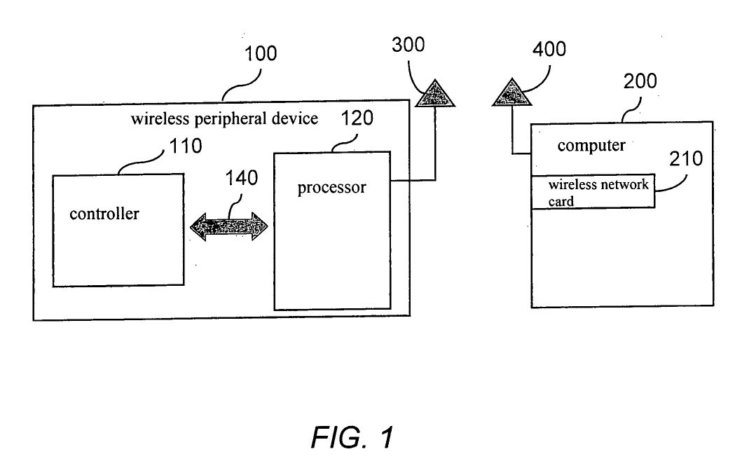

Referring to FIG. 1, the system according to the present invention includes a wireless peripheral device 100 and a computer 200. The peripheral device 100 according to the present invention includes a controller 110 and a processor 120. The controller 110 functions to output an operating signal. The processor 120 receives the operating signal via an interface 140 and formats the operating signal into a data packet which complies with a standard wireless network communication protocol, as described below. The formatting of the operating signal into a data packet can be accomplished using techniques that are well-known in the art (e.g., by reference to IEEE references). The processor 120 wirelessly transmits the data packet through an antenna 300 (at the peripheral device 100) to a wireless network card 210 located within the computer 200 via another antenna 400 (at the computer 200). A program in the computer 200 decodes the data packet and generates a computer control signal to control the operation of the computer 200, such as moving a cursor, or executing a command.

As a non-limiting example, the peripheral device 100 can be embodied in the form of a wireless computer mouse which has a coordinate controller 110 that outputs an operating signal (e.g., cursor control signal). The computer mouse also includes a processor 120 that receives the operating signal via an interface 140, and formats the operating signal into a data packet which complies with a standard wireless network communication protocol. The processor 120 wirelessly transmits the data packet through an antenna 300 (at the mouse) to a wireless network card 210 located within the computer 200 via another antenna 400 (at the computer 200). A program in the computer 200 decodes the data packet and generates a computer control signal to control the movement of a cursor of the computer 200.

If the peripheral device 100 is two-way communication peripheral device (e.g., a joystick, a steering wheel, a game controller, etc.), the computer 200 can wirelessly forward a feedback signal to the peripheral device 100, such as a force feedback signal, vibration feedback signal, or tactile feedback signal, etc.

The standard wireless network communication protocol can be one of the 802.11 serial protocol standard enacted by the IEEE, but not limited to the standard enacted by the IEEE.

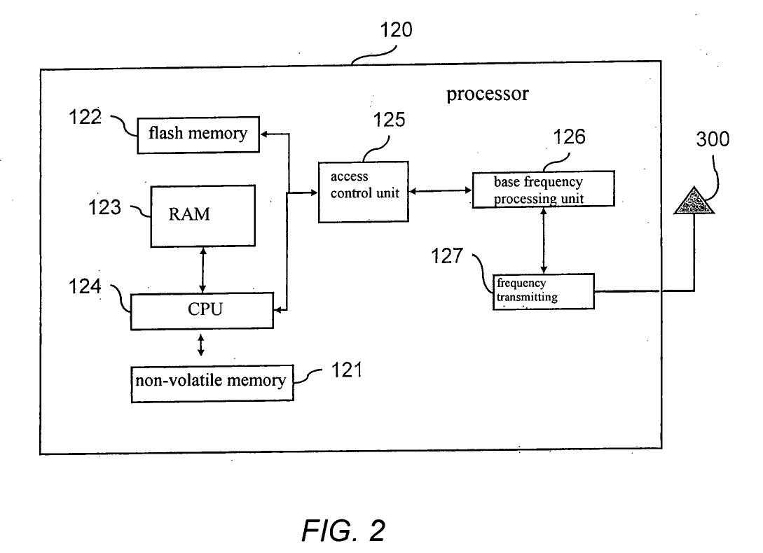

FIG. 2 illustrates the components of the processor 120, which includes a non-volatile memory 121, a flash memory 122, a random-access memory (RAM) 123, a central processing unit (CPU) 124, an access control unit 125, a base frequency processing unit 126, and a frequency transmitting circuit 127.

The non-volatile memory 121 is connected to the CPU 124, and stores the protocol standard of a wireless network. The flash memory 122 stores temporary data while the access control unit 125 is encoding (see below), and has an input coupled to the CPU 124. The RAM 123 is an auxiliary of the the CPU 124, and is bi-directionally coupled to the CPU 124. The access control unit 125 has an input coupled to the output of the CPU 124. The access control unit 125 is bi-directionally coupled to the base frequency processing unit 126, which is in turn bi-directionally coupled to the frequency transmitting circuit 127. The frequency transmitting circuit 127 is coupled to the antenna 300.

The CPU 124 formats the operating signal received from the controller 110 into the desired data packet. The access control unit 125 encodes the data packet to a corresponding Media Access Control (MAC) layer, while the base frequency process unit 126 further encodes the data packet to a corresponding physical (PHY) layer. Finally, the data packet will be converted into a radio frequency signal by the frequency transmitting circuit 127, and wirelessly transmitted via the antenna 300.

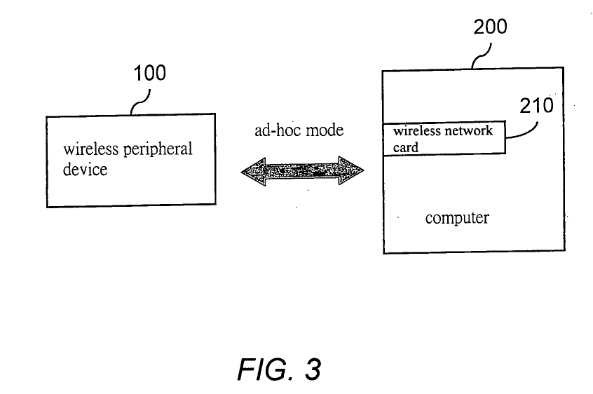

FIG. 3 illustrates the peripheral device 100 transmitting a data packet to the wireless network card 210 of the computer 200 in an ad-hoc mode, which can be utilized when the distance between the peripheral device 100 and the computer 200 is sufficiently small.

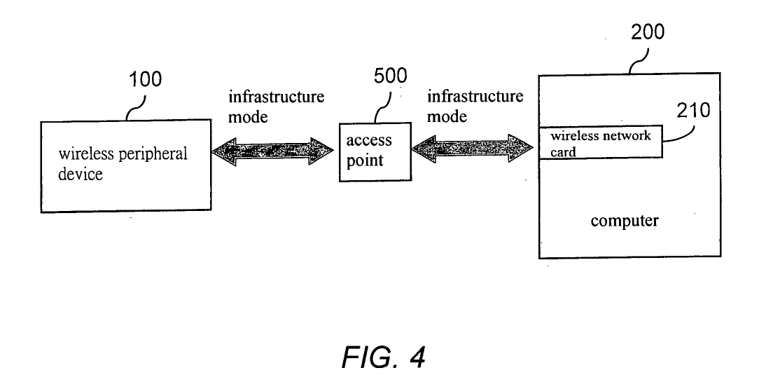

FIG. 4 illustrates the peripheral device 100 transmitting a data packet to the wireless network card 210 of the computer 200 via an access point 500 in an infrastructure mode, which is typically utilized when the distance between the peripheral device 100 and the computer 200 is much greater.

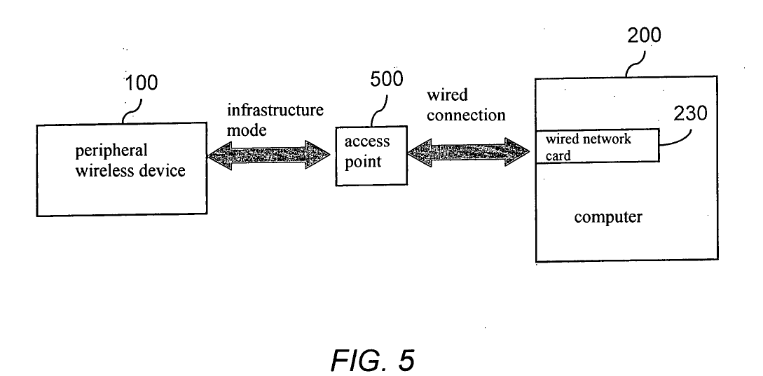

FIG. 5 illustrates the peripheral device 100 wirelessly transmitting a data packet to the access point 500 in the infrastructure mode, and then the access point forwards the data packet to a wired network card 230 of the computer 200 via a wired connection therebetween.

Thus, the present invention provides a peripheral device 100 that can wirelessly communicate with the computer 200 in a network environment so as to not only control the computer 200, but to also link or control several peripheral devices 100 therebetween. Even products from different manufacturers can also be integrated together, following the same communication protocol.

While the description above refers to particular embodiments of the present invention, it will be understood that many modifications may be made without departing from the spirit thereof. The accompanying claims are intended to cover such modifications as would fall within the true scope and spirit of the present invention.

1. A communication system, comprising:
a peripheral device having:
a controller that outputs an operating signal;
a processor that receives the operating signal and formats the operating signal into a data packet that complies with a standard wireless network communication protocol, and then wirelessly transmits the data packet; and
a computer having:
a network card that receives the data packet; and
a program that decodes the data packet into a computer control signal to control the operation of the computer.

2. The system of claim 1, wherein the standard wireless network communication protocol is the 802.11 serial enacted by IEEE.

3. The system of claim 1, wherein the computer wirelessly transmits a feedback signal to the peripheral device.

4. The system of claim 1, wherein the data packet is transmitted in ad-hoc mode.

5. The system of claim 1, further including an access point which receives the data packet from the processor, and which then forwards the data packet to the computer.

6. The system of claim 5, wherein the network card is a wireless network card, and the access point wirelessly forwards the data packet to the computer.

7. The system of claim 5, wherein the network card is a wired network card, and the access point forwards the data packet to the computer in a wired connection.

8. The system of claim 1, wherein the peripheral device is a computer input device.

9. The system of claim 1, wherein the peripheral device is a pointing device.

10. A method of using a peripheral device to control a computer, comprising:
(a) providing a peripheral device that generates a data packet which complies with a standard wireless network communication protocol;
(b) transmitting the data packet to a network card coupled to a computer;
(c) decoding the data packet at the computer to generate a computer control signal; and
(d) using the computer control signal to control the operation of the computer.

11. The method of claim 10, wherein the standard wireless network communication protocol is the 802.11 serial enacted by IEEE.

12. The method of claim 10, further including:
transmitting a feedback signal from the computer to the peripheral device.

13. The method of claim 10, wherein the data packet is transmitted in ad-hoc mode.

14. The method of claim 10, further including:
transmitting the data packet from the processor to an access point; and
transmitting the data packet from the access point to the computer.

15. The method of claim 14, wherein the data packet is wirelessly transmitted from the access point to the computer.

16. The method of claim 14, wherein the data packet is transmitted from the access point to the computer via a wired connection.
